(19) United States
(12) Patent Application Publication
(10) Pub. No.: US 2013/0212119 A1
(43) Pub. Date: Aug. 15, 2013

(54) ORDER DETERMINATION DEVICE, ORDER DETERMINATION METHOD, AND ORDER DETERMINATION PROGRAM

(71) Applicant: Kosuke Yamamoto, Tokyo (JP)

(72) Inventor: Kosuke Yamamoto, Tokyo (JP)

(73) Assignee: NEC CORPORATION, Minato-ku, Tokyo (JP)

(21) Appl. No.: 13/881,110

(22) PCT Filed: Nov. 11, 2011
(86) PCT No.: PCT/JP2011/006315

§ 371 Date: Apr. 23, 2013

(30) Foreign Application Priority Data
Nov. 17, 2010 (JP) 2010-256927

(51) Int. Cl. G06F 17/30

(52) U.S. Cl. CPC G06F 17/30312
USPC 707/758

(57) ABSTRACT

An order determination device orders respective subjects included in a set of subjects to which attribute values are given, in order of how much the respective subjects satisfy a search condition including attributes and attribute values. The order determination device includes: attribute impression level storage means 51 for storing an attribute value and an impression level indicative of an intensity of an impression of the attribute value in association with each other; and importance level adjustment means 52 for decreasing an importance level of a subject according to a magnitude of an impression level of an unspecified attribute value, which is an attribute value included in the subject but not specified by the search condition, when importance levels of the respective subjects indicative of how much the respective subjects satisfy the search condition are calculated.

### TECHNICAL FIELD

The present invention relates to an order determination device, an order determination method, and an order determination program for finding an order based on importance levels of respective subjects with respect to a given search condition when a subject having a certain feature is searched for.

### BACKGROUND ART

In recent years, various subjects including an object in a video image, music, and the like have been able to be searched for as well as a text. Along with an increase in an amount of information to be accumulated, the number of subjects which satisfy a search condition increases. On that account, such a technique is required that a degree of how much the search condition is satisfied is calculated as an importance level so as to increase efficiency in access to necessary information by exhibiting subjects in order of importance.

Non Patent Literature (NPL) 1 describes a video retrieval method in which an importance level per video image is found based on a search condition. The video retrieval method described in NPL 1 is performed in such a manner that assuming that text information such as comments or tags of audiences is given to video images, importance levels of the video images with respect to the search condition (a key word) are found by use of an index in which a video image in which given text information includes a word corresponding to the search condition and the word appears highly frequently is considered important. Further, in a case where a plurality of search conditions are given, such a criterion is provided that a video image in which more words included in the plurality of search conditions are commented with respect to a single scene is considered more important. That is, the video retrieval method described in NPL 1 is a method having the following criteria for the importance level:
a subject including many features satisfying the conditions at the same time; and
a subject of which a feature satisfying the conditions has an important feature value.

Further, Patent Literature (PTL) 1 describes a document retrieval method in which a coincidence degree of a sentence including an opposite expression to a search condition is decreased.

### CITATION LIST

### Patent Literature

PTL: Japanese Patent Application Laid-Open No. 2003-316810

### Non Patent Literature

NPL 1: “Video search technique based on social annotation,” Satoshi Nakamura, Katsumi Tanaka, DEIM (Data Engineering and Information Management) Forum 2009, D6-1

### SUMMARY OF INVENTION

### Technical Problem

An amount of data to be a search subject increases every day. Therefore, the number of subjects which satisfies a search condition also increases. In a case where a given person is searched for from a video image, for example, if a search condition with a feature, such as “white shirt,” by which a subject is hard to be identified is input, many subjects are judged to be important to the same degree by use of a method based on a feature value or an importance level of a feature as described in NPL 1. As a result, it is difficult to order the subjects. In this case, a searcher should check on a large quantity of video information, which is troublesome.

Note that in a case where the document retrieval method described in PTL 1 is employed, if there is an appropriate opposite expression, it is possible to lower an order of a document which deviates from a search purpose of an operator. If there is a document which satisfies a search condition, the document is considered important and an order thereof is increased. In view of this, it is conceivable that the document retrieval method described in PTL 1 is a method which assumes a case where a subject is not characterized well. However, in a case where a search condition by which a subject is hard to be identified is input, there may not be opposite expressions to the search condition. An example of the case is such that there is no opposite expression to a search condition “white shirt.” If it is assumed that an expression “not white shirt” which is in a negative relationship to the above expression is regarded as an opposite expression, to decrease coincidence degrees of people not in white shirts is substantially equivalent to a normal ordering to raise coincidence degrees of people in white shirts. Therefore, there is no significance in regarding a negative expression as an opposite expression. That is, the opposite expression is useless for a case where the ordering cannot be performed with high accuracy only by inputting a search condition by which a subject is difficult to be identified and taking a coincidence degree to the search condition as an index.

In view of this, the present invention is aimed to provide an order determination device, an order determination method, and an order determination program each of which is able to order subjects even in a case where a feature by which a corresponding subject is difficult to be identified is specified as a search condition.

### Solution to Problem

An order determination device according to the present invention is an order determination device for ordering respective subjects included in a set of subjects to which attribute values are given, in order of how much the respective subjects satisfy a search condition including attributes and attribute values, and includes: attribute impression level storage means for storing an attribute value and an impression level indicative of an intensity of an impression of the attribute value in association with each other; and importance level adjustment means for performing a process of decreasing an importance level of a subject according to a magnitude of an impression level of an unspecified attribute value, which is an attribute value of the subject but not included in the search condition, when importance levels of the respective subjects indicative of how much the respective subjects satisfy the search condition are calculated.

An order determination method according to the present invention is an order determination method for ordering respective subjects included in a set of subjects to which attribute values are given, in order of how much the respective subjects satisfy a search condition including attributes and attribute values, and includes: storing an attribute value and an impression level indicative of an intensity of an impression of the attribute value in association with each other; performing a process of decreasing an importance level of a subject according to a magnitude of an impression level of an unspecified attribute value, which is an attribute value included in the subject but not specified by the search condition, when importance levels of the respective subjects indicative of how much the respective subjects satisfy the search condition are calculated; and ordering the respective subjects included in the set based on the importance levels obtained as a result of the above process.

An order determination program according to the present invention is an order determination program for ordering respective subjects included in a set of subjects to which attribute values are given, in order of how much the respective subjects satisfy a search condition including attributes and attribute values, and causes a computer including a storage device for storing an attribute value and an impression level indicative of an intensity of an impression of the attribute value in association with each other, to execute: a process of decreasing an importance level of a subject according to a magnitude of an impression level of an unspecified attribute value, which is an attribute value included in the subject but not specified by the search condition, when importance levels of the respective subjects indicative of how much the respective subjects satisfy the search condition are calculated; and a process of ordering the respective subjects included in the set based on the importance levels obtained as a result of the above process.

### Advantageous Effects of Invention

According to the present invention, it is possible to order subjects even when a search condition to specify a feature by which a subject is hard to be identified is used.

### BRIEF DESCRIPTION OF DRAWINGS

FIG. 1 is a block diagram illustrating an exemplary configuration of an order determination device of an exemplary embodiment of the present invention.

FIG. 2 is an explanatory view illustrating an example of an attribute-attached subject information set.

FIG. 3 is an explanatory view illustrating an example of attribute value impression level information stored in an attribute impression level storage section.

FIG. 4 is an explanatory view illustrating another example of the attribute value impression level information.

FIG. 5 is an explanatory view illustrating further another example of the attribute value impression level information.

FIG. 6 is a flowchart illustrating an example of an operation of the order determination device of the present exemplary embodiment.

FIG. 7 is an explanatory view illustrating an extraction example of an impression level of an unspecified attribute value per subject.

FIG. 8 is an explanatory view illustrating an example of an adjusted importance level.

FIG. 9 is a block diagram illustrating an outline of the present invention.

### DESCRIPTION OF EMBODIMENT(S)

The following describes exemplary embodiments of the present invention with reference to drawings. In the present exemplary embodiment, it is assumed that a searcher has an impression, with respect to a subject, which is felt with five senses such as sight, perception, taste, smell, and touch. For example, in a case where a suspicious person is searched for from video images of neighboring cameras near a crime scene, the searcher is assumed to be an eyewitness of a suspect, a police officer who heard parole evidence from the eyewitness, or the like. Further, in a case where there is impressive music with unknown title, for example, and the music is desired to be searched for from a music database, a user who accesses the music database corresponds to the searcher.

The present invention is based on the premise that “when a searcher searches for a certain subject, a feature of the subject which impresses the searcher more is more easily employed as a search condition.” In the present invention, a feature that should be easy to be used as a search condition is included in a subject. However, in a case where the feature is not included in the search condition actually, a penalty is given to an importance level. That is, an importance level of a subject including a feature which is not included in the search condition though the feature is easy to be used as a search condition, namely, the feature is an impressive feature in the subject is decreased. This makes it possible to perform ordering based on impression levels of features which are not included in a search condition even in a case where a feature by which a subject is hard to be identified is input as the search condition, thereby making it possible for a searcher to omit troubles in search for a desired subject.

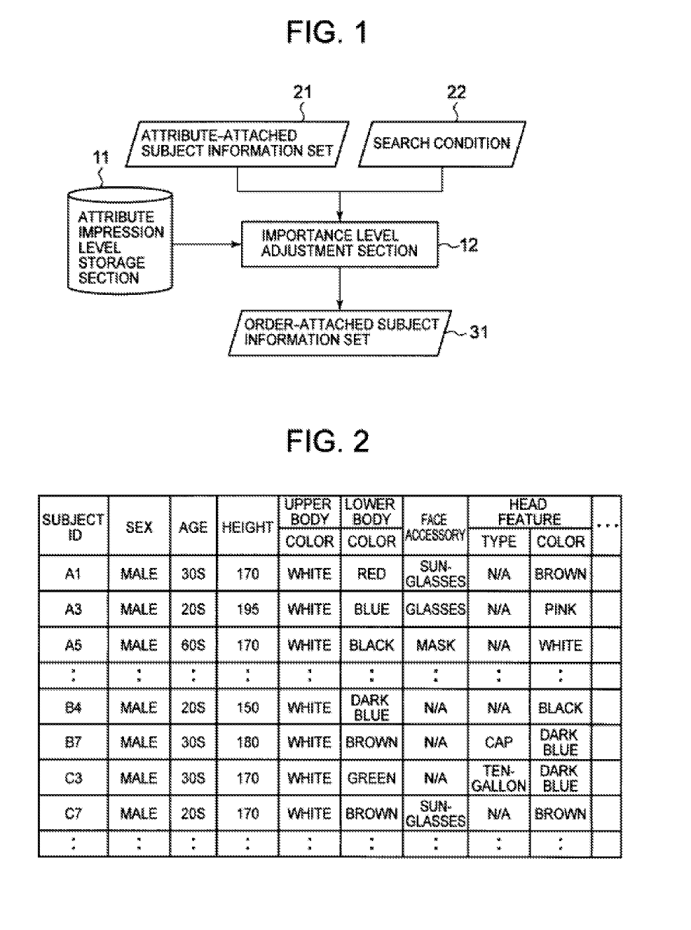

FIG. 1 is a block diagram illustrating an exemplary configuration of an exemplary embodiment of an order determination device according to the present invention. The order determination device illustrated in FIG. 1 orders respective subjects included in a subject set in order of how much the search condition is satisfied. The order determination device includes an attribute impression level storage section 11 and an importance level adjustment section 12. Further, an attribute-attached subject information set 21 and a search condition 22 are input information, and an order-attached subject information set 31 is output information. Although not illustrated herein, the order determination device includes input means corresponding to each piece of input information. Further, the attribute-attached subject information set 21 may be stored in the storage section.

The present exemplary embodiment takes, as an example, a case where when people having a specific feature are retrieved from a video image, the order determination device orders the people thus retrieved. Hereinafter, the subject refers to “person (people).”

The attribute-attached subject information set 21 is a set of subjects (more specifically, information on the subjects) having an attribute. In the present exemplary embodiment, it is assumed that an attribute value is given to each subject. If people are searched for, the attribute is sex, age, outfitting, accessory, and the like. The attribute value is information indicative of a content of each attribute given to a subject. Examples of the information indicative of the content of each attribute are male/female, 20s/30s and 20 years old, red jacket/white shirt, sunglasses/bag, and the like. Note that the attribute-attached subject information set 21 may be indicated in a binary manner such as 0/1 to indicate whether or not there is a certain attribute value or not.

FIG. 2 is an explanatory view illustrating an example of the attribute-attached subject information set 21. In the example illustrated in FIG. 2, sex, age, height, color of an upper body, color of a lower body, accessory on a face such as glasses, type and color of a head feature, and the like are prescribed as attributes with respect to an ID to identify a “person” as a subject. A value (attribute value) of each attribute is given to each subject. As illustrated in FIG. 2, the attribute may be divided into subattributes. For example, the attribute of the head feature is divided into the following attributes: a “type” attribute which assumes a type of a hat and the like as an attribute value; and a “color” attribute which assumes a color of the type attribute as an attribute value. Hereinafter, these subattributes are referred to in such a manner of “parent attribute::subattribute” such as “head feature::type.”

Any attributes are usable in the present exemplary embodiment. Further, each attribute value may be given by a device without hands or may be input and modified by a manual operation. For example, when a video image search targeting “people” is performed, instances (attribute values in the present exemplary embodiment) are given automatically based on a video image analysis technique such as identification of a human area, identification of an accessory, determination of age, and determination of sex. Further, in the example illustrated in FIG. 2, data corresponding to color and the like is expressed in a text format as an attribute value. However, the expression of the attribute value in the text format is an example. If the attribute is “color,” an RGB value, an HSV value, or the like extracted from a video image by the video image analysis technique may be employed as the attribute value. Further, as an attribute value such as sunglasses or glasses for an attribute “face accessory,” a feature value of a video image may be used. Note that the example illustrated in FIG. 2 deals with a subject information set retrieved by attribute values, such as “a man in a white shirt,” by which a subject is hard to be identified, and therefore, such attribute values are exemplified as sex and color of an upper body for all subjects.

In the present exemplary embodiment, the search condition 22 includes a combination of an attribute and an attribute value for a feature of a subject which a searcher is desired to search for. For example, when a given searcher searches for a “person in a white shirt,” the search condition is “upper body::color=white.” Further, the search condition may include a plurality of features. For example, when “a man in a white shirt” is searched for, the search condition includes the following two conditions: “upper body::color=white;” and “sex=male.” Note that these conditions may be combined, and “upper body::color=white” and “sex=male” may be taken as one search condition.

The attribute impression level storage section 11 stores impression levels of the attribute values. The impression level is a value obtained by quantifying how impression is left to a person (i.e., a person is in the general meaning of a searcher herein). The impression level may be quantified in a binary manner of “impressive (1)/hardly impressive (0),” or may be expressed with consecutive values (e.g., values between 0 to 1) according to an intensity of an impression to leave.

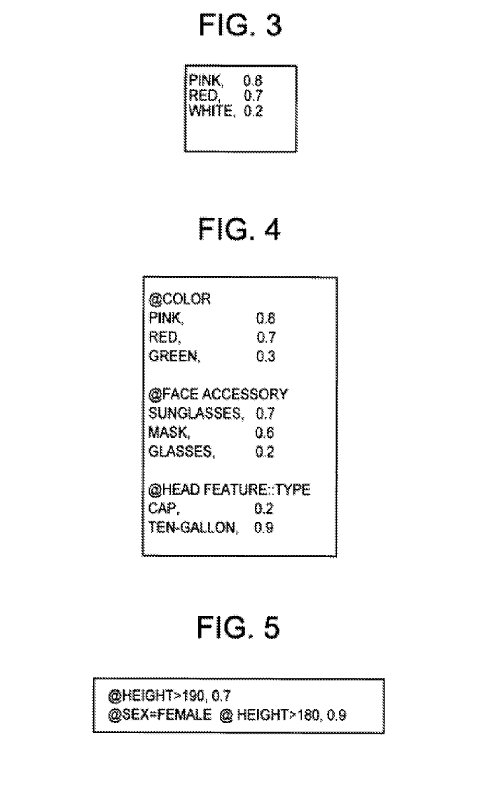

FIG. 3 is an explanatory view illustrating an example of information (hereinafter referred to as attribute value impression level information) stored in the attribute impression level storage section 11. With reference to FIG. 3, the following describes a specification method of an impression level in a case where there is only one type (a color) as an attribute of a subject. In a case where the number of attributes and a content thereof are determined, the impression level may be stored in a format of “a condition of an attribute value to give an impression level, an impression level,” as illustrated in FIG. 3. In the example illustrated in FIG. 3, for example, an impression level of “0.8” is given to an attribute value of “pink.” Note that, in this example, an attribute value to which no impression level is specified is taken as an impression level of “0.”

Further, FIG. 4 is an explanatory view illustrating one example of attribute value impression level information for a plurality of attributes. With reference to FIG. 4, the following describes a specification method of the impression level in a case where there is a plurality of attributes. In the attribute value impression level information illustrated in FIG. 4, an attribute (or its type) is described in a line beginning with “@.” In a plurality of lines below the line with “@,” an attribute value in the attribute and its impression level are described in association with each other. The attribute value and the impression level are described in a format of (attribute value, impression level). In the example illustrated in FIG. 4, in terms of an attribute “face accessory,” an impression level “0.7” is given to an attribute value “sunglasses.” Further, with respect to a “type” attribute, which is a subattribute of “head feature,” it is possible to specify the impression level in such a form of “@ head feature::type.” Note that in regard to a “color” attribute, it is also possible to give different impression levels to the color of an upper body, the color of a lower body, and the color of a head feature. In such a case, for example, a form of “@ head feature::color” and a form of “@ color” are provided so as to give different impression levels to the “color” attribute of the subattribute of the head feature and a “color” attribute other than that.

FIG. 5 is an explanatory view illustrating another example of the attribute value impression level information. With reference to FIG. 5, another example of the specification method of the impression level is explained. In the another example, the impression level is specified according to a rule. That is, the attribute value impression level information is information in which an attribute value of an attribute is associated with a rule to determine an impression level of the attribute value. For example, in the attribute-attached subject information set 21 illustrated in FIG. 2, the height of a person with a target ID=A3 is 195 cm. There are not so many people more than 190 cm in height in Japan. Therefore, it is considered that when a Japanese searcher sees such a person, an impression “tall” will be easily left in the searcher's mind. In this case, in the attribute value impression level information, it is also possible to specify an attribute value to which an impression level is increased, by use of a range of taller than 190 cm.

In the example illustrated in FIG. 5, an attribute beginning with “@” is a variable. That is, that the height is taller than 190 cm is specified as “@ height>190,” and an impression level of an attribute value falling under the range is specified as 0.7. Further, an impression may be determined under a plurality of conditions, for example, as follows: an impression is left when the sex is female and the height is 180 cm or more. FIG. 5 illustrates an example in which a plurality of conditions are specified such as “@ sex=female, @ height>180,” so as to correspond to such conditions. Further, a function to increase an impression level according to the height may be specified as a rule.

Note that a predetermined impression level is specified in the above examples, but it is also possible to automatically set an impression level by performing statistical processing on a set or the like given as a subject information set or a sample. For example, a high impression level may be set to a subject with a low appearance frequency in the set because the subject is rare and notable. Further, in a case of an impression level of color, a high impression level may be set to a color which is highly different from a background color in color saturation or brightness. More specifically, an impression level is set according to an appearance frequency or a magnitude of a difference in color saturation or brightness. As another example, in a case where the appearance frequency or the magnitude of a difference in color saturation or brightness is larger than a predetermined threshold value, a high impression level is set uniformly or step by step. Further, a user may be made watch or listen to sample videos, images, music or the like in advance, and to what feature value the user reacts may be examined statistically.

The importance level adjustment section 12 receives the attribute-attached subject information set 21 and the search condition 22. The importance level adjustment section 12 specifies an unspecified attribute value, which is an attribute value not included in the search condition 22 in regard to each subject included in the attribute-attached subject information set 21. The importance level adjustment section 12 decreases an importance level of a subject having the unspecified attribute value according to a magnitude of an impression level of the unspecified attribute value. The importance level adjustment section 12 may decrease an important level of a subject having a large impression level of the unspecified attribute value. That is, in a case where the impression level of the unspecified attribute value is larger than a predetermined threshold value, the importance level adjustment section 12 may decrease the importance level of the subject. Then, the importance level adjustment section 12 outputs an order-attached subject information set 31 in which respective subjects are in order according to their importance levels. Note that the importance level adjustment section 12 performs a general importance level giving process before a process of decreasing the importance level according to the impression level of the unspecified attribute value. For example, the importance level adjustment section 12 performs a process of giving a high importance level according to an attribute value (a specified attribute value) included in the search condition 22 as the importance level giving process. Note that the importance level adjustment section 12 is able to obtain the impression level of the unspecified attribute value from the attribute impression level storage section 11.

The order-attached subject information set 31 includes information indicative of a result of ordering performed on the respective subjects included in the attribute-attached subject information set 21 thus input. The order-attached subject information set 31 may be, for example, a subject information set to which information indicative of order in the set is given to the respective subjects included in the attribute-attached subject information set 21 thus input.

Note that, in the present exemplary embodiment, the attribute impression level storage section 11 is realized by a storage device such as a memory. Further, the importance level adjustment section 12 is realized by an information processing device such as CPU working according to a program.

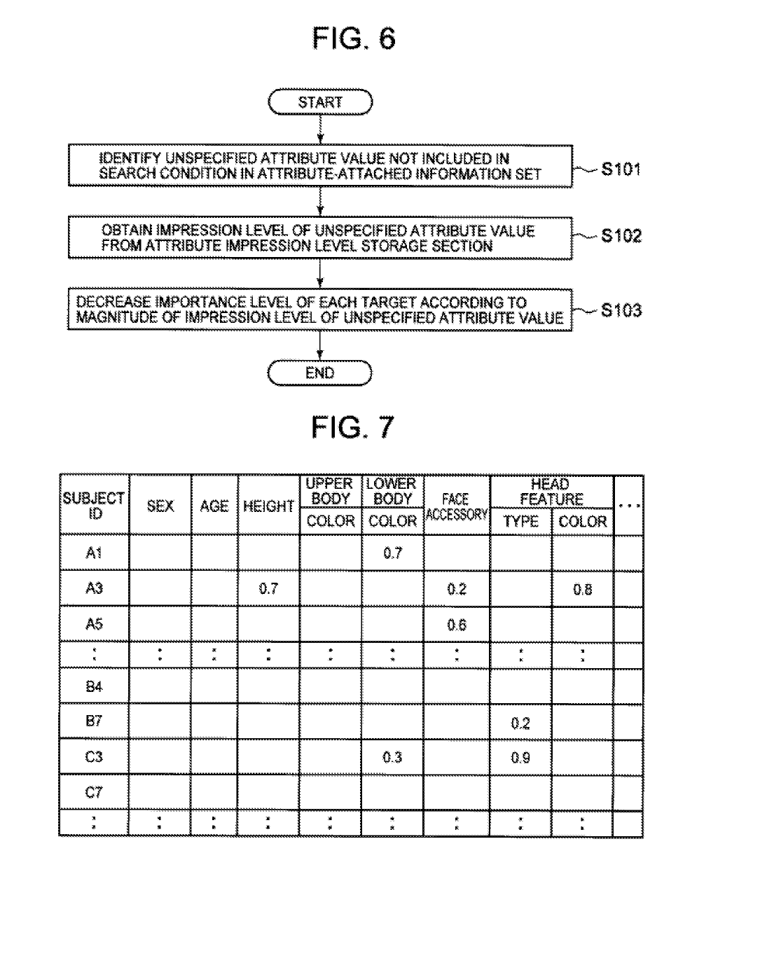

An operation of the present exemplary embodiment is described below. FIG. 6 is a flowchart illustrating an example of an operation of an order determination device of the present exemplary embodiment. As illustrated in FIG. 6, when the attribute-attached subject information set 21 and the search condition 22 are input, the importance level adjustment section 12 receives the attribute-attached subject information set 21 and the search condition 22 and identifies unspecified attribute values of respective subject (step S101).

Subsequently, the importance level adjustment section 12 obtains the impression levels of the unspecified attribute values from the attribute impression level storage section 11 (step S102). The importance level adjustment section 12 decreases an importance level of a subject in which an impression level of an unspecified attribute value is large (step S103). Then, the importance level adjustment section 12 outputs an order-attached subject information set 31 in which the respective subjects are ordered according to their importance levels.

The following describes details of a process executed by the order determination device. Note that, in this example, the attribute-attached subject information set 21 illustrated in FIG. 2 is given, and “upper body::color=white,” “sex=male,” “face accessory=sunglasses,” and “head feature::type=cap” are given as the search condition 22. Further, it is assumed that the attribute value impression level information illustrated in FIGS. 4 and 5 is stored in the attribute impression level storage section 11. Note that it is assumed that contents of respective attributes are included in the search condition 22 so as to be connected by AND, but one or more attributes may be included so as to be connected by OR, or one attribute may include a plurality of contents. Note that a difference in the specification method is taken into consideration in the importance level giving process to be performed before a process of decreasing an importance level according to an impression level of an unspecified attribute value. For example, the specification may be also performed as follows: “upper body::color=white or beige” and “head feature::type=cap” and “head feature::color=pink.”

The importance level adjustment section 12 analyzes the search condition 22 thus input, and identifies which attribute is specified and which attribute value in the attribute is specified so as to identify a subject. For example, in a case where the search condition is determined to be described in such a predetermined format as “attribute=attribute value,” the importance level adjustment section 12 may extract a part before “=” as the attribute and a part after “=” as the attribute value. In a case where the attribute-attached subject information set 21 illustrated in FIG. 2 is used, the importance level adjustment section 12 identifies that an attribute value “white” is specified in regard to an attribute “upper body::color,” and similarly, identifies that “male” is specified in regard to “sex,” “sunglasses” is specified in regard to “face accessory,” and “cap” is specified in regard to “head feature::type.”

The importance level adjustment section 12 judges whether or not each attribute value of each subject in the attribute-attached subject information set 21 is included in the search condition 22. Here, an attribute value which is not included in the search condition 22 is referred to as an unspecified attribute value.

Initially, the importance level adjustment section 12 identifies an attribute which is not included in the search condition 22. A whole set of attributes may be stored in the importance level adjustment section 12 in advance. Note that every time the attribute-attached subject information set 21 is given, the importance level adjustment section 12 may identify the attributes.

The importance level adjustment section 12, for example, prepares flags (hereinafter referred to as an attribute specification flag) for all the attributes assigned in the attribute-attached subject information set 21, and initializes values of respective flags with false. After that, by rewriting an attribute specification flag corresponding to an attribute included in the search condition 22 with true, the attribute specified in the search condition 22 is identified. Attribute values of attributes with false are unspecified attribute values.

In the example illustrated in FIG. 2, such attributes as “height,” “age,” “lower body::color,” and the like which are attributes not included in the search condition 22 fall under false, and attribute values of those attributes are extracted as unspecified attribute values. The importance level adjustment section 12 initially judges whether or not an attribute is included in the search condition 22, so that it is not necessary to examine individual attribute values, thereby making it possible to increase a processing speed of search.

Further, the importance level adjustment section 12 judges whether or not an attribute value of an attribute which is turned into true satisfies the search condition 22. When performing the judgment, the importance level adjustment section 12 forms an index to a subject having an attribute value per attribute value of each attribute in advance, so as to obtain a complementary set of subjects which satisfy a condition per attribute included in the search condition 22, thereby achieving speedup of the process.

For example, in the present exemplary embodiment, since “face accessory=sunglasses” is included in the search condition 22, if an index to associate “face accessory=sunglasses” with “subject ID=A1 and C7” is formed, the importance level adjustment section 12 is able to judge that attribute values assigned to subjects other than the subject IDs=A1 and C7 in terms of the attribute “face accessory” are all unspecified attribute values.

Subsequently, the importance level adjustment section 12 refers to the attribute impression level storage section 11 and obtains impression levels of the unspecified attribute values. If a pair of an attribute and an attribute value is determined by referring to attribute value impression level information stored in the attribute impression level storage section 11, the importance level adjustment section 12 is able to obtain an impression level of the attribute value uniquely. Note that an impression level is obtained quickly if information of the attribute impression level storage section 11 is stored in a hash table which assumes the pair of the attribute and the attribute value as a key and the impression level as a value. In the example illustrated in FIG. 2, attribute values of attributes given to a subject with a subject ID=A3 are as follows, for example: height=195, face accessory=glasses, and head feature::color=pink. Thus, the importance level adjustment section 12 obtains impression levels of 0.7, 0.2, and 0.8 with respect to those unspecified attribute values, based on the attribute value impression level information (information illustrated in FIGS. 4 and 5 in the present exemplary embodiment) stored in the attribute impression level storage section 11. Note that an impression level of an attribute value not included in the attribute value impression level information is assumed 0 in the present exemplary embodiment. Therefore, the importance level adjustment section 12 obtains 0 as attribute values for other attributes.

The impression levels of the unspecified attribute values per subject, which are obtained in the above manner, are illustrated in FIG. 7. FIG. 7 is an explanatory view illustrating an extraction example of an impression level of an unspecified attribute value per subject. In regard to a subject with a subject ID=A1 in the example illustrated in FIG. 7, for example, the importance level adjustment section 12 obtains 0.7 as an impression level for an unspecified attribute value of lower body::color=red. Further, in regard to a subject ID=C3, for example, the importance level adjustment section 12 obtains 0.3 as an impression level for an unspecified attribute value of lower body::color=green, and 0.9 as an impression level for an unspecified attribute value of head feature::type=ten-gallon.

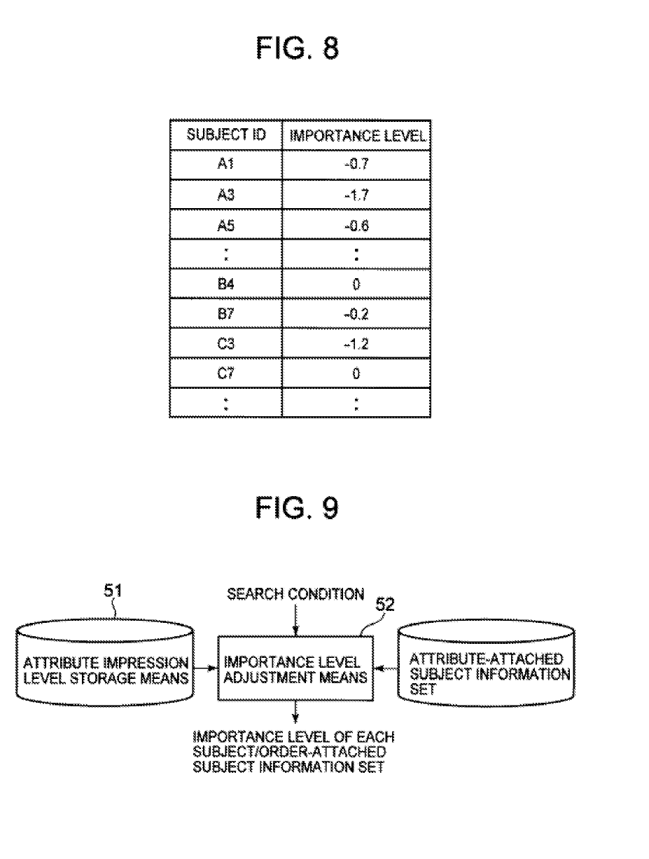

The importance level adjustment section 12 decreases an important level of each subject according to a magnitude of an impression level of an unspecified attribute value thereof. Briefly, impression levels of unspecified attribute values of each subject are added and its value is subtracted from the importance level of the subject. For example, in the example illustrated in FIG. 7, the importance level adjustment section 12 decreases an importance level of a subject with a subject ID=A3 by 1.7. Here, FIG. 8 illustrates an example of an importance level adjusted by this process when it is assumed that an importance level of each subject in the attribute-attached subject information set 21 is set to “0” in advance without any difference.

In the example illustrated in FIG. 8, an importance level of the subject with the subject ID=A3 is −1.7, for example. Further, an importance level of a subject with a subject ID=B4 is ±0, for example. As apparent from the example illustrated in FIG. 8, an importance level of a subject, such as the subject ID=A3, which includes many attributes with high impression levels but of which the attributes are not included in the search condition is largely decreased.

As such, by adjusting the importance level based on an impression level of an attribute value not included in the search condition, it is possible to decrease orders of subjects other than a desired subject. Accordingly, it is possible to perform ordering appropriately in order of a subject closer to an impression specified by the search condition. Particularly, even in a case where a feature by which a subject is hard to be identified is specified, it is possible to perform ordering appropriately in order of a subject closer to an impression specified by the search condition. As a result, a searcher is able to check a desired subject without many troubles of checking barrage of information.

Next will be described the importance level adjustment section 12 in another embodiment. Even in a case of the same unspecified attribute value, it may be preferable to give different importance levels to different attributes. For example, in a case where information about color is unclear because witness information about a subject is made during nighttime, if the search condition does not include an attribute about color, it is not preferable to order subjects based on an impression level of the attribute.

In view of this, in the present exemplary embodiment, the importance level adjustment section 12 determines a weighting level of an attribute, and uses the weighting level as a weight to an impression level of an unspecified attribute value. That is, the importance level adjustment section 12 weights an impression level of an unspecified attribute value in each subject with a weighting level of an attribute to which the attribute value is given, and then calculates a sum of respective impression levels as an importance level of the subject. That is, a weighted sum of the respective impression levels is calculated. Note that, weighting of the weighting level is, for example, multiplication by the weighting level.

In the present exemplary embodiment, the unspecified attribute values are classified into two largely. A first one is as follows: in a case where the search condition does not include an attribute, an attribute value of the attribute is considered to be an unspecified attribute value. A second one is as follows: although the search condition includes an attribute value, an attribute value is different from that in the search condition and therefore is considered to be an unspecified attribute value. That is, even an attribute value included in the search condition will be considered as an unspecified attribute value under a predetermined condition.

According to the process, an attribute specification flag=false is obtained in regard to an attribute corresponding to the first unspecified attribute value, but an attribute specification flag=true is obtained in regard to an attribute corresponding to the second unspecified attribute value. However, in the case of the second unspecified attribute value, the attribute value is clearly different from the attribute value included in the search condition. It is considered that a subject having such an attribute value is largely different from a subject desired to be searched for by the search condition. In view of this, in order to decrease an order of such a subject, the importance level adjustment section 12 may perform a process of adjusting an importance level by a weighted sum after increasing a weighting level of a corresponding attribute. For example, the importance level adjustment section 12 may perform a process of increasing a weighting level of an attribute included in the search condition 22 to be larger than a default value, to be larger than a weighting level of an attribute not included in the search condition, or the like. Note that the weighting level of an attribute may be specified by a searcher. Alternatively, in order that a weighting level of an attribute included in the search condition 22 is larger than usual or larger than a weighting level of an attribute not included in the search condition, importance levels of other attributes may be uniformly made smaller than a default value or the weighting level of the attribute not included in the search condition may be made lighter.

The importance level adjustment section 12 performs ordering based on the importance levels. After the importance level adjustment section 12 sorts the attribute-attached subject information set 21 according to the order, the importance level adjustment section 12 outputs the attribute-attached subject information set 21 to an output section (not illustrated) as an order-attached subject information set 31. The importance level adjustment section 12 sorts subject IDs in order of importance levels, for example, and outputs information indicative of a result thereof (sort order) and a subject information set to the output section.

As such, with the use of the importance levels found by weighted sums using weighting levels of respective attribute which are set according to the search condition, it is possible to perform ordering which depends on an important attribute in the search condition, thereby making it possible to sequentially check a subject information set in order from a subject closer to an impression specified by the search condition.

Note that, the above embodiment deals with, as an example, a scene in which suspicious people are ordered by searching a set of surveillance video images based on witness testimonies of people who witnessed a suspect, but the search according to the present invention is not limited to a video image search. For example, music also leaves an impression to people. Accordingly, with the use of the same configuration as the above exemplary embodiment, the present invention is applicable to a music search. In that case, for example, an intensive drum sound is taken as a feature, and an impression level is given to it.

Note that, in the above exemplary embodiment, the importance level adjusting process using an impression level of an unspecified attribute value is performed after a general importance level giving process, but an importance level calculation section including a function of the importance level adjustment section 12 may be provided. In that case, the importance level calculation section may calculate an importance level in the process of calculating an importance level of each subject so that an importance level of a subject having an unspecified attribute value eventually is decreased according to a magnitude of an impression level of the unspecified attribute value.

The following describes an outline of the present invention. FIG. 9 is a block diagram illustrating the outline of the present invention. As illustrated in FIG. 9, an order determination device of the present invention is an order determination device for ordering respective subjects included in a set of subjects (an attribute-attached subject information set) to which attribute values are given, in order of how much the respective subjects satisfy a search condition including attributes and attribute values, and includes attribute impression level storage means 51 and importance level adjustment means 52.

The attribute impression level storage means 51 (e.g., the attribute impression level storage section 11) stores an attribute value and an impression level indicative of an intensity of an impression of the attribute value in association with each other. The attribute-attached subject information set may be input with the search condition as input information, may be stored in advance in a storage device included in the order determination device, or may be stored in an external storage device. Note that in a case where the attribute-attached subject information set is stored in an external storage device, the order determination device should include means for reading a subject set from the storage device.

The importance level adjustment means 52 (e.g., the importance level adjustment section 12) decreases an importance level of a subject according to a magnitude of an impression level of an unspecified attribute value, which is an attribute value of the subject but not included in the search condition, when importance levels of the respective subjects indicative of how much the respective subject satisfy the search condition are calculated.

Further, the importance level adjustment means 52 may calculate a sum of impression levels of unspecified attribute values of the subject and subtract the sum thus found from the importance level of the subject.

Further, the importance level adjustment means 52 may weight the impression level of the unspecified attribute value of the subject by a weight of an attribute, perform a calculation of a sum of impression levels as a weighted sum, and subtract the sum thus found from the importance level of the subject.

Further, the importance level adjustment means 52 may make a weight to an attribute included in the search condition heavier than a weight preset to the attribute or a weight to an attribute not included in the search condition, and performs a calculation of the sum of impression levels and the attribute value included in the search condition. Note that the process of making the weight heavier includes a process of uniformly decreasing weights of other attributes to be smaller than preset weights or making the weight to the attribute not included in the search condition lighter so that the weight to the attribute included in the search condition is relatively heavier eventually.

Further, the importance level adjustment means 52 may decrease the importance level of the subject according to a magnitude of an impression level of an unspecified attribute value larger than a predetermined threshold value.

Further, the attribute impression level storage means 51 may store an attribute value of a subject included in the subject set and a rule to determine an impression level of the attribute value in association with each other.

The present invention has been described with reference to the exemplary embodiments and examples as described above, but the present invention is not limited to the exemplary embodiments and the examples. Various changes that a person skilled in the art can understand can be made for the configuration and details of the present invention within a scope of the present invention.

This application claims priority based on Japanese Patent Application No. 2010-256927 filed on Nov. 17, 2010, the entire contents of which are hereby incorporated by reference.

### INDUSTRIAL APPLICABILITY

The present invention is not limited to systems and the like in which a feature that is hard to be identified is specified in a search condition, but is also preferably applicable to a purpose of ordering respective subjects included in a set of subjects to which attributes are given, for example, for the sake of exhibiting a listing effective to a user.

### REFERENCE SIGNS LIST

11 . . . Attribute impression level storage section
12 . . . Importance level adjustment section
21 . . . Attribute-attached subject information set
22 . . . Search condition
31 . . . Order-attached subject information set
51 . . . Attribute impression level storage means
52 . . . Importance level adjustment means

What is claimed is:

1. An order determination device for ordering respective subjects included in a set of subjects to which attribute values are given, in order of how much the respective subjects satisfy a search condition including attributes and attribute values, the order determination device comprising:
an attribute impression level storage unit which stores an attribute value and an impression level indicative of an intensity of an impression of the attribute value in association with each other; and
an importance level adjustment unit which performs a process of decreasing an importance level of a subject according to a magnitude of an impression level of an unspecified attribute value, which is an attribute value of the subject but not included in the search condition, when importance levels of the respective subjects indicative of how much the respective subjects satisfy the search condition are calculated.

2. The order determination device according to claim 1, wherein:
the importance level adjustment unit calculates a sum of impression levels of unspecified attribute values of the subject and subtracts the sum thus calculated from the importance level of the subject.

3. The order determination device according to claim 1, wherein:
the importance level adjustment unit weights the impression level of the unspecified attribute value of the subject with a weight of an attribute, performs a calculation of a sum of impression levels as a weighted sum, and subtracts the sum thus found from the importance level of the subject.

4. The order determination device according to claim 3, wherein:
the importance level adjustment unit makes a weight to an attribute included in the search condition heavier than a weight preset to the attribute or a weight to an attribute not included in the search condition, and performs a calculation of the sum of impression levels and the attribute value included in the search condition.

5. The order determination device according to claim 1, wherein:
the importance level adjustment unit decreases the importance level of the subject according to a magnitude of an impression level of an unspecified attribute value larger than a predetermined threshold value.

6. The order determination device according to claim 1, wherein:
the attribute impression level storage unit stores an attribute value of a subject included in the set and a rule to determine an impression level of the attribute value in association with each other.

7. An order determination method for ordering respective subjects included in a set of subjects to which attribute values are given, in order of how much the respective subjects satisfy a search condition including attributes and attribute values, the order determination method comprising:
storing an attribute value and an impression level indicative of an intensity of an impression of the attribute value in association with each other;
performing a process of decreasing an importance level of a subject according to a magnitude of an impression level of an unspecified attribute value, which is an attribute value included in the subject but not specified by the search condition, when importance levels of the respective subjects indicative of how much the respective subjects satisfy the search condition are calculated; and
ordering the respective subjects included in the set based on the importance levels obtained as a result of the above process.

8. A non-transitory computer readable information recording medium storing an order determination program for ordering respective subjects included in a set of subjects to which attribute values are given, in order of how much the respective subjects satisfy a search condition including attributes and attribute values, when executed by a processor including a storage device for storing an attribute value and an impression level indicative of an intensity of an impression of the attribute value in association with each other, performs:
a process of decreasing an importance level of a subject according to a magnitude of an impression level of an unspecified attribute value, which is an attribute value included in the subject but not specified by the search condition, when importance levels of the respective subjects indicative of how much the respective subjects satisfy the search condition are calculated; and
a process of ordering the respective subjects included in the set based on the importance levels obtained as a result of the above process.

9. The order determination device according to claim 2, wherein:
the importance level adjustment unit decreases the importance level of the subject according to a magnitude of an impression level of an unspecified attribute value larger than a predetermined threshold value.

10. The order determination device according to claim 3, wherein:
the importance level adjustment unit decreases the importance level of the subject according to a magnitude of an impression level of an unspecified attribute value larger than a predetermined threshold value.

11. The order determination device according to claim 4, wherein:
the importance level adjustment unit decreases the importance level of the subject according to a magnitude of an impression level of an unspecified attribute value larger than a predetermined threshold value.

12. The order determination device according to claim 2, wherein:
the attribute impression level storage unit stores an attribute value of a subject included in the set and a rule to determine an impression level of the attribute value in association with each other.

13. The order determination device according to claim 3, wherein:
the attribute impression level storage unit stores an attribute value of a subject included in the set and a rule to determine an impression level of the attribute value in association with each other.

14. The order determination device according to claim 4, wherein:
the attribute impression level storage unit stores an attribute value of a subject included in the set and a rule to determine an impression level of the attribute value in association with each other.
